(19) United States
(12) Patent Application Publication
(10) Pub. No.: US 2012/0075853 A1
(43) Pub. Date: Mar. 29, 2012

(54) LIGHT EMITTING DIODE DEVICE WITH HIGHER HEAT DISSIPATION AND CONTROLLABLE LIGHT PATTERN

(75) Inventor: TSUNG-EIN TSAI, TAIPEI CITY (TW)

(73) Assignee: ANN CHENG ENTERPRISE CO., LTD., CHIAYI COUNTY (TW)

(21) Appl. No.: 13/235,604

(22) Filed: Sep. 19, 2011

(30) Foreign Application Priority Data
Sep. 27, 2010 (TW) 099218539

(51) Int. Cl. F21V 29/00; F21V 7/22; F21V 7/00

(52) U.S. Cl. 362/235

(57) ABSTRACT

A light emitting diode device with higher heat dissipation and controllable light pattern is revealed. The light emitting diode device includes a light fixture reflector and a plurality of light emitting diodes fixed on surface of the light fixture reflector. By heat conduction, heat convection, and heat radiation of electrons of the light fixture reflector, heat is dissipated. Light pattern is controlled by adjustment of reflection angle of the light fixture reflector. Thus the manufacturing cost is reduced and the light emitting diode device is having more practical value.

### BACKGROUND OF THE INVENTION

1. Field of the Invention

The present invention relates to a light emitting diode device with higher heat dissipation and controllable light pattern, especially to a light emitting diode device that dissipates heat directly by a light fixture reflector and control light patterns by adjusting reflection angle of the light fixture reflector. Moreover, the cost is reduced and the LED device is of higher practical value.

2. Description of Related Art

Generally, light emitting diode light sources available now use heat sinks for heat dissipation. Heat generated from LED is conducted to the heat sink with large surface area. Then heat radiation and heat convection occur due to the larger surface area and shape of the heat sink so as to remove heat from LED efficiently.

Although efficient heat dissipation is achieved by the above way, the heat sink with large surface area occupies a certain space and the shape of the light fixture with the LED light source is limited. Thus complicated optical design is required to get the required light pattern.

Refer to Taiwanese Pat. Pub. No. M380446 published at May 11, 2000-“LED WITH LIGHT DESIGN AND HEAT DISSIPATION”, a LED light is revealed. The LED light includes a transparent cover containing phosphor, a blue light emitting diode (LED) in the transparent cover, and aluminum heat sink. The heat sink includes multiple layers of aluminum sheets and a hollow aluminum tube. The layers of aluminum sheets are integrated with the hollow aluminum tube. The blue LED is fixed on base over a top of the hollow aluminum tube of the heat sink by surface mount technology.

Although the above LED light gets the expected light pattern without secondary light design. In practice, the amount of phosphors required in the transparent cover for control of light pattern is quite a few due to the large surface area of the transparent cover. This results in an increased manufacturing cost.

Thus there is room for improvement and a need to provide a novel LED device with better heat dissipation and controllable light pattern that overcomes the shortcomings mentioned above.

### SUMMARY OF THE INVENTION

Therefore it is a primary object of the present invention to provide a light emitting diode device with higher heat dissipation and controllable light pattern that includes a plurality of light emitting diodes fixed on surface of a light fixture reflector. By repetitive cycles of conduction, convection and radiation of electrons of the light fixture reflector, heat generated is dissipated. The light pattern is controlled by adjustment of reflection angle of the light fixture reflector. The manufacturing cost of the LED device is reduced and the LED device is of higher practical value.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a schematic drawing showing structure of an embodiment according to the present invention;

FIG. 2 is a schematic drawing showing structure of another embodiment according to the present invention;

FIG. 3 is a schematic drawing showing heat conduction of the present invention;

FIG. 4 is a schematic drawing showing heat convection of the present invention;

FIG. 5 is a schematic drawing showing heat radiation of the present invention.

### DETAILED DESCRIPTION OF THE PREFERRED EMBODIMENT

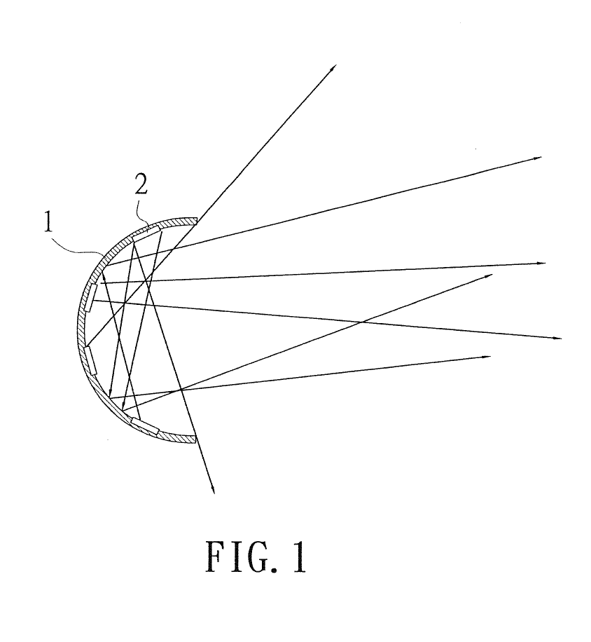

Refer to FIG. 1, a plurality of light emitting diodes (LEDs) 2 is disposed on a light fixture reflector 1. The LEDs 2 are attached to and fixed on a surface of the light fixture reflector 1 by surface mount technology (SMT). The light fixture reflector 1 is made from conductive materials such as metal having copper, silver, gold, aluminum, etc. or their alloys. Or the light fixture reflector 1 is made from semiconductor materials such as silicon, germanium or a composite silicon-germanium. The light fixture reflector 1 can also be made from oxide ceramics, nitride ceramics, boride ceramics, etc.

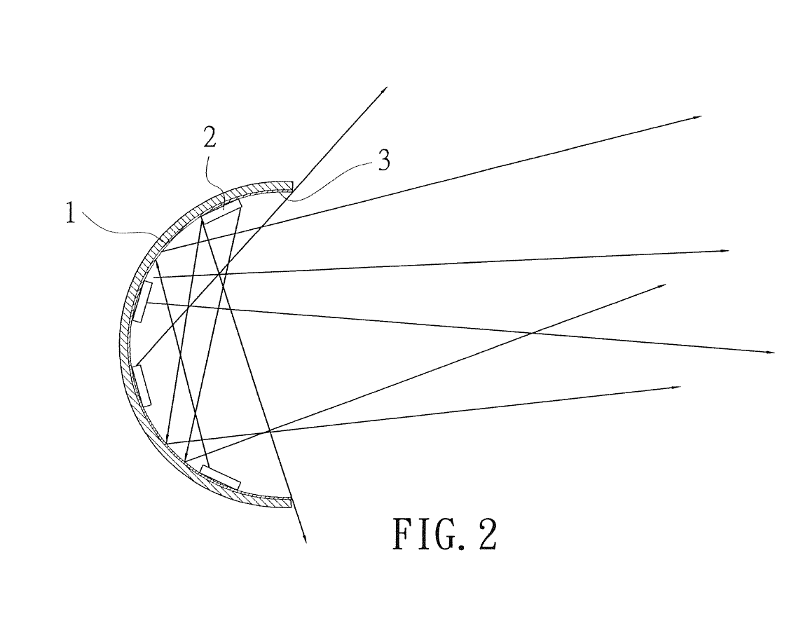

Refer to FIG. 2, another embodiment of the present invention is revealed. The embodiment further includes a flexible substrate 3. Each LED 2 is soldered or attached to the surface of the flexible substrate 3 by SMT. And the LEDs 2 are connected to one another by wires. Then the flexible substrate 3 together with the LEDs 2 is connected to and fixed on a light fixture reflector 1.

The visible light is reflected by surfaces of objects. If the surface roughness is less than wavelength of the visible light, the interference of the reflected light is stronger along the direction of reflection. At the same time, electrons on surface of reflecting objects move about the wavelength of visible light (0.4˜0.7 10⁻⁶ m) to create electromagnetic resonance for increasing percentage of the light reflected. Based on the above information, the reflector is made from materials having de-localized electrons such as conductor, semiconductor, etc.

While in use, when each LED 2 emits light, heat generated from the LED 2 is quickly conducted to electrons 11 on the surface of the light fixture reflector 1 vertically because that each LED 2 is in contact with the surface of the light fixture reflector 1 and the de-localized electrons on the surface of the light fixture reflector 1 that do not reside along a single bond move under visible light. Moreover, the moving speed of the electrons at high temperature is faster than that at low temperature. There are three ways that heat transfers in the environment-conduction, convection, and radiation. Each heat exchange occurs by one of the three ways or their combinations. The density of these de-localized electrons is quite high (about 1019 electrons in 1 cm³). After obtaining heat from the

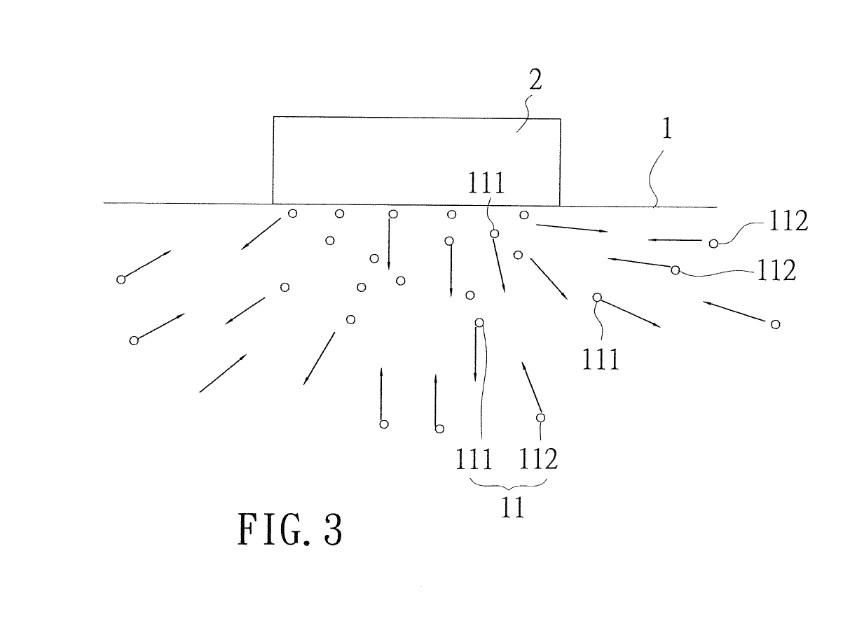

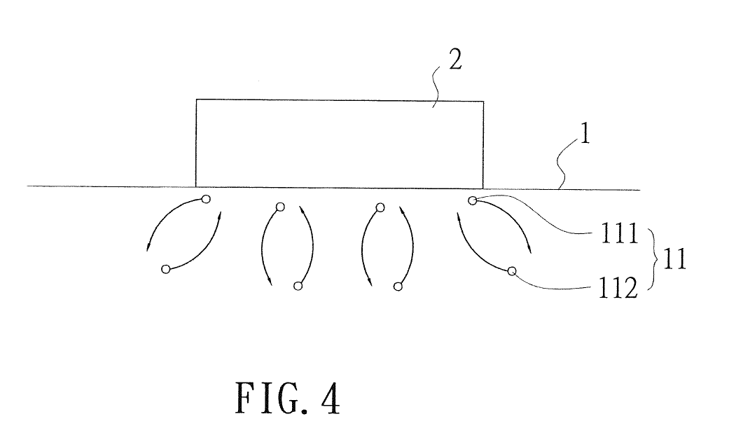

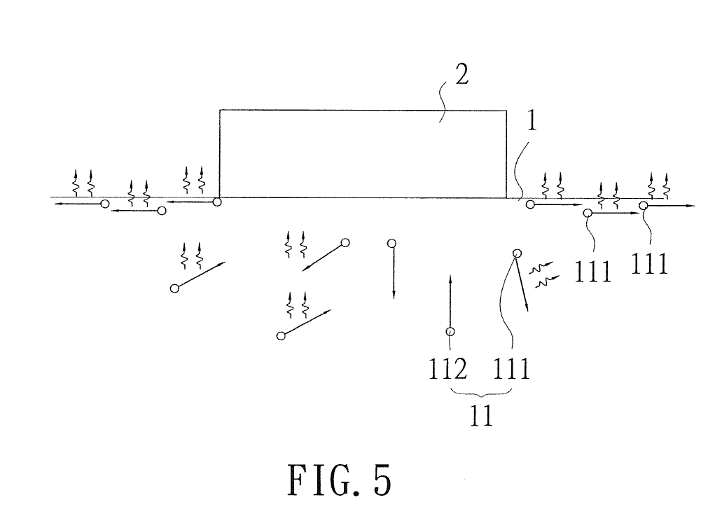

LED 2, the de-localized electrons become high temperature electrons 111. Due to diffusion, each high temperature electron 111 leaves its original position quickly and moves to a lower temperature position so as to bring heat energy from the higher temperature position effectively and heat conduction occurs, as shown in FIG. 3. Once each high temperature electron 111 of the light fixture reflector 1 leaving the high temperature position due to diffusion, a positive change area is generated on the original position immediately. Thus negatively charged low temperature electrons 112 at lower temperature positions nearby are attracted by the high temperature positive charge area so as to move toward the high temperature positive charge area due to electric fields and charge neutralization is achieved. A convection current is set up due to movement of the high temperature electrons 111 and the low temperature electrons 112, as shown in FIG. 4. At the same time, low frequency electromagnetic radiation is generated due to convection between the high temperature electrons 111 and the low temperature electrons 112. The low frequency electromagnetic radiation also carries energy for heat transfer. Heat is emitted to outside by radiation, as shown in FIG. 5. Thereby heat generated from each LED 2 fixed on the light fixture reflector 1 is transferred and dissipated effectively by repetitive cycles of conduction, convection and radiation of the electrons 11.

Furthermore, the reflection surface of the light fixture reflector 1 is a curved surface. Thus beam angle of each LED 2 is smaller or equal to 120 degrees and the light from each LED 2 is reflected by the curved surface of the light fixture reflector 1. For example, while LED devices being used as light tubes, the smaller the beam angle, the better the concentration efficiency. When the beam angle is smaller than 60 degrees, the LED device can be applied to projection light sources or flashlight light sources and the light pattern is controlled.

In use, twenty-eight 1 Watt LEDs 2 are set on the light fixture reflector 1 whose area is 15 cm×15 cm. With 28 W power supply, the 28 LEDs 2 are lit up at room temperature (23 Celsius degrees °C.) and the electrode temperature of the LED 2, close to the temperature of lighting area, is only 40° C. When these LEDs 2 with 28 W power supply are 8 meters above the ground and the width of an illumination area on the ground is 10 m, the light intensity of the illumination area down vertically is 15 lux (lumens per square meter).

In summary, compared with the structure available now, the LED device of the present invention dissipates heat by conduction, convection, and radiation of electrons of the light fixture reflector. Moreover, light pattern is controlled by adjusting reflection angle of the light fixture reflector. Therefore the manufacturing cost is down and the LED device is of higher practical value.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A light emitting diode device with higher heat dissipation and controllable light pattern comprising: a light fixture reflector and a plurality of light emitting diodes fixed on a surface of the light fixture reflector; wherein heat generated from light emitting diodes is dissipated by heat conduction, heat convection and heat radiation of electrons in the light fixture reflector while light pattern is controlled by adjusting angle of reflection on a curved surface of the light fixture reflector.

2. The device as claimed in claim 1, wherein a flexible substrate is arranged between the light fixture reflector and the light emitting diodes; each of light emitting diodes is fixed on the flexible substrate and the light emitting diodes are connected by wires; the flexible substrate together with the light emitting diodes is connected to and fixed on the light fixture reflector.

3. The device as claimed in claim 1, wherein the light fixture reflector is made from conductor.

4. The device as claimed in claim 3, wherein the light fixture reflector is made from metal conductor.

5. The device as claimed in claim 4, wherein the light fixture reflector is made from metal alloy.

6. The device as claimed in claim 1, wherein the light fixture reflector is made from semiconductor.

7. The device as claimed in claim 6, wherein the light fixture reflector is made from semiconductor composite material.

8. The device as claimed in claim 1, wherein the light fixture reflector is made from ceramic.

9. The device as claimed in claim 1, wherein the light emitting diodes are soldered to the surface of the light fixture reflector by surface mount technology.

10. The device as claimed in claim 1, wherein the light emitting diodes are attached to and fixed on the surface of the light fixture reflector by surface mount technology.
